(19) United States
(12) Patent Application Publication
(10) Pub. No.: US 2018/0240045 A1
(43) Pub. Date: Aug. 23, 2018

(54) SYSTEMS AND METHODS FOR ALLOCATING SHARABLE ORDERS

(71) Applicant: BEIJING DIDI INFINITY TECHNOLOGY AND DEVELOPMENT CO., LTD., Beijing (CN)

(72) Inventors: Lingyu ZHANG, Beijing (CN); Hongjing SUN, Beijing (CN); Yang MENG, Beijing (CN); Li HE, Beijing (CN); Yang ZHANG, Beijing (CN); Wei CHENG, Beijing (CN)

(73) Assignee: BEIJING DIDI INFINITY TECHNOLOGY AND DEVELOPMENT CO., LTD., Beijing (CN)

(21) Appl. No.: 15/963,090

(22) Filed: Apr. 25, 2018

Related U.S. Application Data
(63) Continuation of application No. PCT/CN2016/107353, filed on Nov. 25, 2016.

(30) Foreign Application Priority Data
Nov. 26, 2015 (CN) 201510846367.X
Feb. 19, 2016 (CN) 201610093904.2

(51) Int. Cl. G06Q 10/02; G06Q 10/04; G06Q 10/06; H04L 29/08; G06Q 50/30

(52) U.S. Cl. CPC G06Q 10/025; G06Q 10/047; G06Q 50/30; H04L 67/32; H04L 67/18; G06Q 10/063

(57) ABSTRACT

The present disclosure relates to systems and methods for allocating a plurality of orders. The systems may perform the methods to obtain a plurality of orders, wherein each order may be associated with a request of a service and include a plurality of features; determine matching information of the plurality of orders based on the features of the plurality of orders; determine a set of sharable orders based on the matching information; allocate the set of sharable orders, wherein the allocation may result in a maximum profit value associated with a combination of at least two sharable orders of the set of sharable orders; and send the combination of the at least two sharable orders to a service provider.

### CROSS-REFERENCE TO RELATED APPLICATIONS

This application is a continuation of International Application No. PCT/CN2016/107353, filed on Nov. 25, 2016, which designates the United States of America and claims priority to Chinese Application No. 201510846367.X filed on Nov. 26, 2015 and Chinese Application No. 201610093904.2 filed on Feb. 19, 2016, the contents of which are incorporated herein by reference in their entirety.

### TECHNICAL FIELD

The present disclosure generally relates to systems and methods for on-demand service, and in particular, systems and methods for allocating sharable orders of transportation services.

### BACKGROUND

With the development of Internet technology, on-demand transportation services, such as online taxi hailing services, have become more and more popular. Through an online transportation service platform, a requestor may request a transportation service in the form of an order through an application installed in a user equipment, such as a smart phone terminal. Then a server of the platform may broadcast the order to service providers. In some cases, when two or more orders are sufficiently similar, the server may determine that the orders are sharable and allocate the shareable orders to the service providers. For example, when start locations of two taxing hailing orders are close enough, the server may combine the two orders into one, so that a taxi may pick up the corresponding two passengers and serve them together.

### SUMMARY

According to an aspect of the present disclosure, a system may include one or more storage media and one or more processors configured to communicate with the one or more storage media. The one or more storage media may include a set of instructions for allocating a plurality of orders. When the one or more processors executing the set of instructions, the one or more processors may be directed to perform one or more of the following operations. The one or more processors may obtain a plurality of orders, wherein each order may be associated with a request of a service and include a plurality of features. The one or more processors may determine matching information of the plurality of orders based on the features of the plurality of orders. The one or more processors may determine a set of sharable orders based on the matching information. The one or more processors may allocate the set of sharable orders, wherein the allocation may result in a maximum profit value associated with a combination of at least two sharable orders of the set of sharable orders. The one or more processors may send the combination of the at least two sharable orders to a service provider.

In some embodiments, the plurality of orders may include at least one of a real-time order, an appointment order, and/or a pending order.

In some embodiments, the features of the plurality of orders may include at least one of a start location, a destination, a mileage, a number of passengers, a pick-up time, an estimated fee, freight information, and/or vehicle information.

In some embodiments, the one or more processors may determine a plurality of parameters associated with the features or the matching information. The one or more processors may determine a plurality of weighting coefficients for the plurality of parameters. The one or more processors may determine a plurality of relevance probabilities based on the plurality of parameters and the plurality of weighting coefficients, wherein each of the plurality of relevance probabilities may correspond to two sharable orders in the set of sharable orders. The one or more processors may determine a plurality of relevance values based on the plurality of relevance probabilities, wherein each of the relevance values may correspond to two sharable orders in the set of sharable orders. The one or more processors may then allocate the set of sharable orders based on the plurality of relevance values.

In some embodiments, the plurality of weighting coefficients may be determined by training historical data.

In some embodiments, the one or more processors may determine a maximum value of a sum of the plurality of relevance values. The one or more processors may divide the set of sharable orders into a plurality of order groups based on the maximum value, wherein each group may include two sharable orders. The one or more processors may then allocate the set of sharable orders based on the plurality of order groups.

In some embodiments, the one or more processors may allocate the set of sharable orders based at least in part on a hill-climbing algorithm, a genetic algorithm, and/or a simulated annealing algorithm.

In some embodiments, the one or more processors may determine a first feature of a first order. The one or more processors may determine a plurality of pending orders within a predetermined distance from the first order, wherein the plurality of pending orders may correspond to a plurality of providers. The one or more processors may determine a plurality of second features of the plurality of second pending orders, wherein each of the plurality of second features may correspond to a second pending order. The one or more processors may match the first feature with the plurality of second features. The one or more processors may then determine the matching information.

In some embodiments, the first feature may include at least one of a first start location, a first destination, and/or first freight information.

In some embodiments, the first freight information may include at least one of a type of the freight, a length of the freight, a width of the freight, a height of the freight, and/or a weight of the freight.

In some embodiments, each of the plurality of second features may include at least one of a location of the provider, a second destination of the pending order, and/or second vehicle information.

In some embodiments, the second vehicle information may include at least one of a truck volume and/or a load capacity.

In some embodiments, the one or more processors may determine a plurality of candidate pending orders based on the matching information, wherein the plurality of candidate pending orders may correspond to a plurality of candidate providers. The one or more processors may determine a plurality of distances between a plurality of locations of the plurality of candidate providers and the first start location, wherein each of the plurality of distances may correspond to one of the plurality of candidate providers. The one or more processors may rank the plurality of candidate providers based on the plurality of distances. The one or more processors may then allocate the first order to the plurality of candidate providers based on the ranking result.

According to another aspect of the present disclosure, a method may include one or more of the following operations. A computer server may obtain a plurality of orders, wherein each order may be associated with a request of a service and include a plurality of features. The computer server may determine matching information of the plurality of orders based on the features of the plurality of orders. The computer server may determine a set of sharable orders based on the matching information. The computer server may allocate the set of sharable orders, wherein the allocation may result in a maximum profit value associated with a combination of at least two sharable orders of the set of sharable orders. The computer server may send the combination of the at least two sharable orders to a service provider.

In some embodiments, the plurality of orders may include at least one of a real-time order, an appointment order, and/or a pending order.

In some embodiments, the features of the plurality of orders may include at least one of a start location, a destination, a mileage, a number of passengers, a pick-up time, an estimated fee, freight information, and/or vehicle information.

In some embodiments, the computer server may determine a plurality of parameters associated with the features or the matching information. The computer server may determine a plurality of weighting coefficients for the plurality of parameters. The computer server may determine a plurality of relevance probabilities based on the plurality of parameters and the plurality of weighting coefficients, wherein each of the plurality of relevance probabilities may correspond to two sharable orders in the set of sharable orders. The computer server may determine a plurality of relevance values based on the plurality of relevance probabilities, wherein each of the relevance values may correspond to two sharable orders in the set of sharable orders. The computer server may then allocate the set of sharable orders based on the plurality of relevance values.

In some embodiments, the plurality of weighting coefficients may be determined by training historical data.

In some embodiments, the computer server may determine a maximum value of a sum of the plurality of relevance values. The computer server may divide the set of sharable orders into a plurality of order groups based on the maximum value, wherein each group may include two sharable orders. The computer server may then allocate the set of sharable orders based on the plurality of order groups.

In some embodiments, the computer server may allocate the set of sharable orders based at least in part on a hill-climbing algorithm, a genetic algorithm, and/or a simulated annealing algorithm.

In some embodiments, the computer server may determine a first feature of a first order. The computer server may determine a plurality of pending orders within a predetermined distance from the first order, wherein the plurality of pending orders may correspond to a plurality of providers. The computer server may determine a plurality of second features of the plurality of second pending orders, wherein each of the plurality of second features may correspond to a second pending order. The computer server may match the first feature with the plurality of second features. The computer server may then determine the matching information.

In some embodiments, the first feature may include at least one of a first start location, a first destination, and/or first freight information.

In some embodiments, the first freight information may include at least one of a type of the freight, a length of the freight, a width of the freight, a height of the freight, and/or a weight of the freight.

In some embodiments, each of the plurality of second features may include at least one of a location of the provider, a second destination of the pending order, and/or second vehicle information.

In some embodiments, the second vehicle information may include at least one of a truck volume and/or a load capacity.

In some embodiments, the computer server may determine a plurality of candidate pending orders based on the matching information, wherein the plurality of candidate pending orders may correspond to a plurality of candidate providers. The computer server may determine a plurality of distances between a plurality of locations of the plurality of candidate providers and the first start location, wherein each of the plurality of distances may correspond to one of the plurality of candidate providers. The computer server may rank the plurality of candidate providers based on the plurality of distances. The computer server may then allocate the first order to the plurality of candidate providers based on the ranking result.

Additional features will be set forth in part in the description which follows, and in part will become apparent to those skilled in the art upon examination of the following and the accompanying drawings or may be learned by production or operation of the examples. The features of the present disclosure may be realized and attained by practice or use of various aspects of the methodologies, instrumentalities and combinations set forth in the detailed examples discussed below.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 is a block diagram illustrating an exemplary on-demand service system according to some embodiments of the present disclosure;

FIG. 2 is a block diagram illustrating an exemplary computing device in the on-demand service system according to some embodiments of the present disclosure;

FIG. 3 is a block diagram illustrating an exemplary processing engine according to some embodiments of the present disclosure;

FIG. 4 is a flowchart illustrating an exemplary process/method 400 for allocating a set of sharable orders according to some embodiments of the present disclosure;

FIG. 5-A is an exemplary list illustrating first features of a first order according to some embodiments of the present disclosure;

FIG. 5-B is an exemplary list illustrating second features of a second order according to some embodiments of the present disclosure;

FIG. 5-C is an exemplary list illustrating matching information of the first order and the second order according to some embodiments of the present disclosure;

FIGS. 6-A through FIG. 6-C are schematic diagrams illustrating an exemplary process/method 600 for determining a set of sharable orders according to some embodiments of the present disclosure;

FIG. 7 is a flowchart illustrating an exemplary process/method 700 for allocating the set of sharable orders according to some embodiments of the present disclosure; and

FIG. 8 is a flowchart illustrating an exemplary process/method 800 for allocating an order according to some embodiments of the present disclosure.

### DETAILED DESCRIPTION

The following description is presented to enable any person skilled in the art to make and use the present disclosure, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present disclosure is not limited to the embodiments shown, but is to be accorded the widest scope consistent with the claims.

The terminology used herein is for the purpose of describing particular example embodiments only and is not intended to be limiting. As used herein, the singular forms “a,” “an,” and “the” may be intended to include the plural forms as well, unless the context clearly indicates otherwise. It will be further understood that the terms “comprise,” “comprises,” and/or “comprising,” “include,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

These and other features, and characteristics of the present disclosure, as well as the methods of operation and functions of the related elements of structure and the combination of parts and economies of manufacture, may become more apparent upon consideration of the following description with reference to the accompanying drawings, all of which form a part of this disclosure. It is to be expressly understood, however, that the drawings are for the purpose of illustration and description only and are not intended to limit the scope of the present disclosure. It is understood that the drawings are not to scale.

The flowcharts used in the present disclosure illustrate operations that systems implement according to some embodiments in the present disclosure. It is to be expressly understood, the operations of the flowchart may be implemented not in order. Conversely, the operations may be implemented in inverted order, or simultaneously. Moreover, one or more other operations may be added to the flowcharts. One or more operations may be removed from the flowcharts.

Moreover, while the system and method in the present disclosure is described primarily in regard to allocate a set of sharable orders, it should also be understood that this is only one exemplary embodiment. The system or method of the present disclosure may be applied to any other kind of on demand service. For example, the system or method of the present disclosure may be applied to transportation systems of different environments including land, ocean, aerospace, or the like, or any combination thereof. The vehicle of the transportation systems may include a taxi, a private car, a hitch, a bus, a train, a bullet train, a high speed rail, a subway, a vessel, an aircraft, a spaceship, a hot-air balloon, a driverless vehicle, or the like, or any combination thereof. The transportation system may also include any transportation system for management and/or distribution, for example, a system for sending and/or receiving an express. The application of the system or method of the present disclosure may include a webpage, a plug-in of a browser, a client terminal, a custom system, an internal analysis system, an artificial intelligence robot, or the like, or any combination thereof.

The term “passenger,” “requester,” “service requester,” and “customer” in the present disclosure are used interchangeably to refer to an individual, an entity or a tool that may request or order a service. Also, the term “driver,” “provider,” “service provider,” and “supplier” in the present disclosure are used interchangeably to refer to an individual, an entity or a tool that may provide a service or facilitate the providing of the service. The term “user” in the present disclosure may refer to an individual, an entity or a tool that may request a service, order a service, provide a service, or facilitate the providing of the service. For example, the user may be a passenger, a driver, an operator, or the like, or any combination thereof. In the present disclosure, “passenger” and “passenger terminal” may be used interchangeably, and “driver” and “driver terminal” may be used interchangeably.

The term “service request” and “order” in the present disclosure are used interchangeably to refer to a request that may be initiated by a passenger, a requester, a service requester, a customer, a driver, a provider, a service provider, a supplier, or the like, or any combination thereof. The service request may be accepted by any one of a passenger, a requester, a service requester, a customer, a driver, a provider, a service provider, or a supplier. The service request may be chargeable or free.

The positioning technology used in the present disclosure may be based on a global positioning system (GPS), a global navigation satellite system (GLONASS), a compass navigation system (COMPASS), a Galileo positioning system, a quasi-zenith satellite system (QZSS), a wireless fidelity (WiFi) positioning technology, or the like, or any combination thereof. One or more of the above positioning systems may be used interchangeably in the present disclosure.

An aspect of the present disclosure relates to online systems and methods for finding sharable and/or combinable transportation transactions, such as taxi hailing. The systems and methods may do so by determining matching information of a plurality of orders, determining a set of sharable orders based on the matching information, and allocating a set of sharable orders. When allocating the set of sharable orders, the systems and methods may determine a plurality of relevance values and allocate the set of sharable orders based on the plurality of relevance values.

It should be noted that online on-demand transportation service, such as online taxi hailing including taxi hailing combination services, is a new form of service rooted only in post-Internet era. It provides technical solutions to users and service providers that could raise only in post-Internet era. In pre-Internet era, when a user hails a taxi on street, the taxi request and acceptance occur only between the passenger and one taxi driver that sees the passenger. If the passenger hails a taxi through telephone call, the service request and acceptance may occur only between the passenger and one service provider (e.g., one taxi company or agent). Online taxi, however, allows a user of the service to real-time and automatic distribute a service request to a vast number of individual service providers (e.g., taxi) distance away from the user. It also allows a plurality of service provides to respond to the service request simultaneously and in real-time. Therefore, through Internet, the online on-demand transportation systems may provide a much more efficient transaction platform for the users and the service providers that may never met in a traditional pre-Internet transportation service system.

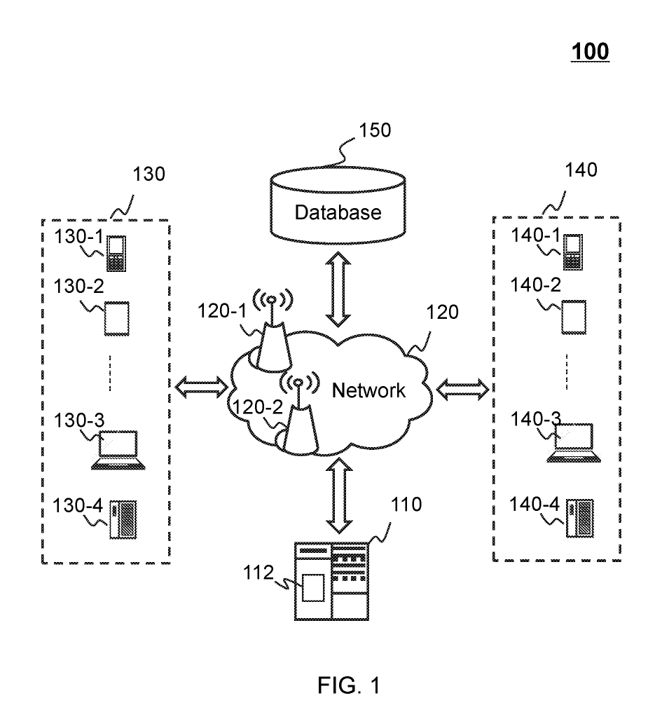

FIG. 1 is a block diagram of an exemplary on-demand service system 100 according to some embodiments. For example, the on-demand service system 100 may be an online transportation service platform for transportation services such as taxi hailing, chauffeur service, express car, carpool, bus service, driver hire and shuttle service. The on-demand service system 100 may be an online platform including a server 110, a network 120, a requestor terminal 130, a provider terminal 140, and a database 150. The server 110 may include a processing engine 112.

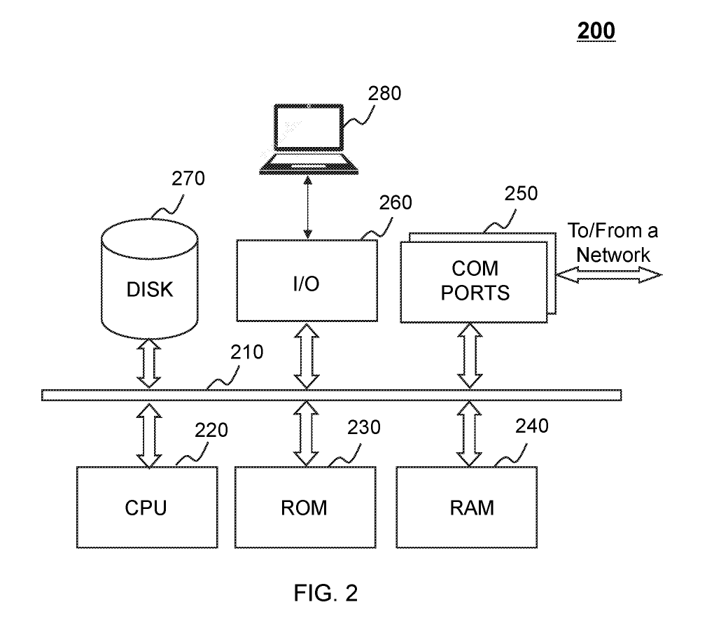

In some embodiments, the server 110 may be a single server, or a server group. The server group may be centralized, or distributed (e.g., server 110 may be a distributed system). In some embodiments, the server 110 may be local or remote. For example, the server 110 may access information and/or data stored in the requestor terminal 130, the provider terminal 140, and/or the database 150 via the network 120. As another example, the server 110 may be directly connected to the requestor terminal 130, the provider terminal 140, and/or the database 150 to access stored information and/or data. In some embodiments, the server 110 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof. In some embodiments, the server 110 may be implemented on a computing device 200 having one or more components illustrated in FIG. 2 in the present disclosure.

In some embodiments, the server 110 may include a processing engine 112. The processing engine 112 may process information and/or data relating to the service request to perform one or more functions described in the present disclosure. For example, the processing engine 112 may determine matching information of a plurality of orders, determine a set of sharable orders based on the matching information, and allocate a set of sharable orders. In some embodiments, the processing engine 112 may include one or more processing engines (e.g., single-core processing engine(s) or multi-core processor(s)). Merely by way of example, the processing engine 112 may include a central processing unit (CPU), an application-specific integrated circuit (ASIC), an application-specific instruction-set processor (ASIP), a graphics processing unit (GPU), a physics processing unit (PPU), a digital signal processor (DSP), a field programmable gate array (FPGA), a programmable logic device (PLD), a controller, a microcontroller unit, a reduced instruction-set computer (RISC), a microprocessor, or the like, or any combination thereof.

The network 120 may facilitate exchange of information and/or data. In some embodiments, one or more components in the on-demand service system 100 (e.g., the server 110, the requestor terminal 130, the provider terminal 140, and the database 150) may send information and/or data to other component(s) in the on-demand service system 100 via the network 120. For example, the server 110 may obtain/acquire service request from the requestor terminal 130 via the network 120. In some embodiments, the network 120 may be any type of wired or wireless network, or combination thereof. Merely by way of example, the network 130 may include a cable network, a wireline network, an optical fiber network, a tele communications network, an intranet, an Internet, a local area network (LAN), a wide area network (WAN), a wireless local area network (WLAN), a metropolitan area network (MAN), a wide area network (WAN), a public telephone switched network (PSTN), a Bluetooth network, a ZigBee network, a near field communication (NFC) network, or the like, or any combination thereof. In some embodiments, the network 120 may include one or more network access points. For example, the network 120 may include wired or wireless network access points such as base stations and/or internet exchange points 120-1, 120-2, . . . , through which one or more components of the on-demand service system 100 may be connected to the network 120 to exchange data and/or information.

In some embodiments, a requestor may be a user of the requestor terminal 130. In some embodiments, the user of the requestor terminal 130 may be someone other than the requestor. For example, a user A of the requestor terminal 130 may use the requestor terminal 130 to send a service request for a user B, or receive service and/or information or instructions from the server 110. In some embodiments, a provider may be a user of the provider terminal 140. In some embodiments, the user of the provider terminal 140 may be someone other than the provider. For example, a user C of the provider terminal 140 may user the provider terminal 140 to receive a service request for a user D, and/or information or instructions from the server 110. In some embodiments, “requestor” and “requestor terminal” may be used interchangeably, and “provider” and “provider terminal” may be used interchangeably.

In some embodiments, the requestor terminal 130 may include a mobile device 130-1, a tablet computer 130-2, a laptop computer 130-3, a built-in device in a motor vehicle 130-4, or the like, or any combination thereof. In some embodiments, the mobile device 130-1 may include a smart home device, a wearable device, a smart mobile device, a virtual reality device, an augmented reality device, or the like, or any combination thereof. In some embodiments, the smart home device may include a smart lighting device, a control device of an intelligent electrical apparatus, a smart monitoring device, a smart television, a smart video camera, an interphone, or the like, or any combination thereof. In some embodiments, the wearable device may include a smart bracelet, a smart footgear, a smart glass, a smart helmet, a smart watch, a smart clothing, a smart backpack, a smart accessory, or the like, or any combination thereof. In some embodiments, the smart mobile device may include a smartphone, a personal digital assistance (PDA), a gaming device, a navigation device, a point of sale (POS) device, or the like, or any combination thereof. In some embodiments, the virtual reality device and/or the augmented reality device may include a virtual reality helmet, a virtual reality glass, a virtual reality patch, an augmented reality helmet, an augmented reality glass, an augmented reality patch, or the like, or any combination thereof. For example, the virtual reality device and/or the augmented reality device may include a Google Glass, an Oculus Rift, a Hololens, a Gear VR, etc. In some embodiments, built-in device in the motor vehicle 130-4 may include an onboard computer, an onboard television, etc. In some embodiments, the requestor terminal 130 may be a device with positioning technology for locating the position of the requestor and/or the requestor terminal 130.

In some embodiments, the provider terminal 140 may be similar to, or the same device as the requestor terminal 130. In some embodiments, the provider terminal 140 may be a device with positioning technology for locating the position of the provider and/or the provider terminal 140. In some embodiments, the requestor terminal 130 and/or the provider terminal 140 may communicate with other positioning device to determine the position of the requestor, the requestor terminal 130, the provider, and/or the provider terminal 140. In some embodiments, the requestor terminal 130 and/or the provider terminal 140 may send positioning information to the server 110.

The database 150 may store data and/or instructions. In some embodiments, the database 150 may store data obtained from the requestor terminal 130 and/or the provider terminal 140. In some embodiments, the database 150 may store data and/or instructions that the server 110 may execute or use to perform exemplary methods described in the present disclosure. In some embodiments, database 150 may include a mass storage, a removable storage, a volatile read-and-write memory, a read-only memory (ROM), or the like, or any combination thereof. Exemplary mass storage may include a magnetic disk, an optical disk, a solid-state drives, etc. Exemplary removable storage may include a flash drive, a floppy disk, an optical disk, a memory card, a zip disk, a magnetic tape, etc. Exemplary volatile read-and-write memory may include a random access memory (RAM). Exemplary RAM may include a dynamic RAM (DRAM), a double date rate synchronous dynamic RAM (DDR SDRAM), a static RAM (SRAM), a thyristor RAM (T-RAM), and a zero-capacitor RAM (Z-RAM), etc. Exemplary ROM may include a mask ROM (MROM), a programmable ROM (PROM), an erasable programmable ROM (PEROM), an electrically erasable programmable ROM (EEPROM), a compact disk ROM (CD-ROM), and a digital versatile disk ROM, etc. In some embodiments, the database 150 may be implemented on a cloud platform. Merely by way of example, the cloud platform may include a private cloud, a public cloud, a hybrid cloud, a community cloud, a distributed cloud, an inter-cloud, a multi-cloud, or the like, or any combination thereof.

In some embodiments, the database 150 may be connected to the network 120 to communicate with one or more components in the on-demand service system 100 (e.g., the server 110, the requestor terminal 130, the provider terminal 140, etc.). One or more components in the on-demand service system 100 may access the data or instructions stored in the database 150 via the network 120. In some embodiments, the database 150 may be directly connected to or communicate with one or more components in the on-demand service system 100 (e.g., the server 110, the requestor terminal 130, the provider terminal 140, etc.). In some embodiments, the database 150 may be part of the server 110.

In some embodiments, one or more components in the on-demand service system 100 (e.g., the server 110, the requestor terminal 130, the provider terminal 140, etc.) may have a permission to access the database 150. In some embodiments, one or more components in the on-demand service system 100 may read and/or modify information relating to the requestor, provider, and/or the public when one or more conditions are met. For example, the server 110 may read and/or modify one or more users' information after a service. As another example, the provider terminal 140 may access information relating to the requestor when receiving a service request from the requestor terminal 130, but the provider terminal 140 may not modify the relevant information of the requestor.

In some embodiments, information exchanging of one or more components in the on-demand service system 100 may be achieved by way of requesting a service. The object of the service request may be any product. In some embodiments, the product may be a tangible product, or an immaterial product. The tangible product may include food, medicine, commodity, chemical product, electrical appliance, clothing, car, housing, luxury, or the like, or any combination thereof. The immaterial product may include a servicing product, a financial product, a knowledge product, an internet product, or the like, or any combination thereof. The internet product may include an individual host product, a web product, a mobile internet product, a commercial host product, an embedded product, or the like, or any combination thereof. The mobile internet product may be used in a software of a mobile terminal, a program, a system, or the like, or any combination thereof. The mobile terminal may include a tablet computer, a laptop computer, a mobile phone, a personal digital assistance (PDA), a smart watch, a point of sale (POS) device, an onboard computer, an onboard television, a wearable device, or the like, or any combination thereof. For example, the product may be any software and/or application used in the computer or mobile phone. The software and/or application may relate to socializing, shopping, transporting, entertainment, learning, investment, or the like, or any combination thereof. In some embodiments, the software and/or application relating to transporting may include a traveling software and/or application, a vehicle scheduling software and/or application, a mapping software and/or application, etc. In the vehicle scheduling software and/or application, the vehicle may include a horse, a carriage, a rickshaw (e.g., a wheelbarrow, a bike, a tricycle, etc.), a car (e.g., a taxi, a bus, a private car, etc.), a train, a subway, a vessel, an aircraft (e.g., an airplane, a helicopter, a space shuttle, a rocket, a hot-air balloon, etc.), or the like, or any combination thereof.

FIG. 2 is a schematic diagram illustrating exemplary hardware and software components of a computing device 200 on which the server 110, the requestor terminal 130, and/or the provider terminal 140 may be implemented according to some embodiments of the present disclosure. For example, the processing engine 112 may be implemented on the computing device 200 and configured to perform functions of the processing engine 112 disclosed in this disclosure.

The computing device 200 may be a general purpose computer or a special purpose computer, both may be used to implement an on-demand system for the present disclosure. The computing device 200 may be used to implement any component of the on-demand service as described herein. For example, the processing engine 112 may be implemented on the computing device 200, via its hardware, software program, firmware, or a combination thereof. Although only one such computer is shown, for convenience, the computer functions relating to the on-demand service as described herein may be implemented in a distributed fashion on a number of similar platforms, to distribute the processing load.

The computing device 200, for example, may include COM ports 250 connected to and from a network connected thereto to facilitate data communications. The computing device 200 may also include a central processing unit (CPU) 220, in the form of one or more processors, for executing program instructions. The exemplary computer platform may include an internal communication bus 210, program storage and data storage of different forms, for example, a disk 270, and a read only memory (ROM) 230, or a random access memory (RAM) 240, for various data files to be processed and/or transmitted by the computer. The exemplary computer platform may also include program instructions stored in the ROM 230, RAM 240, and/or other type of non-transitory storage medium to be executed by the CPU 220. The methods and/or processes of the present disclosure may be implemented as the program instructions. The computing device 200 also includes an I/O component 260, supporting input/output between the computer and other components therein such as user interface elements 280. The computing device 200 may also receive programming and data via network communications.

Merely for illustration, only one CPU and/or processor is described in the computing device 200. However, it should be note that the computing device 200 in the present disclosure may also include multiple CPUs and/or processors, thus operations and/or method steps that are performed by one CPU and/or processor as described in the present disclosure may also be jointly or separately performed by the multiple CPUs and/or processors. For example, if in the present disclosure the CPU and/or processor of the computing device 200 executes both step A and step B, it should be understood that step A and step B may also be performed by two different CPUs and/or processors jointly or separately in the computing device 200 (e.g., the first processor executes step A and the second processor executes step B, or the first and second processors jointly execute steps A and B).

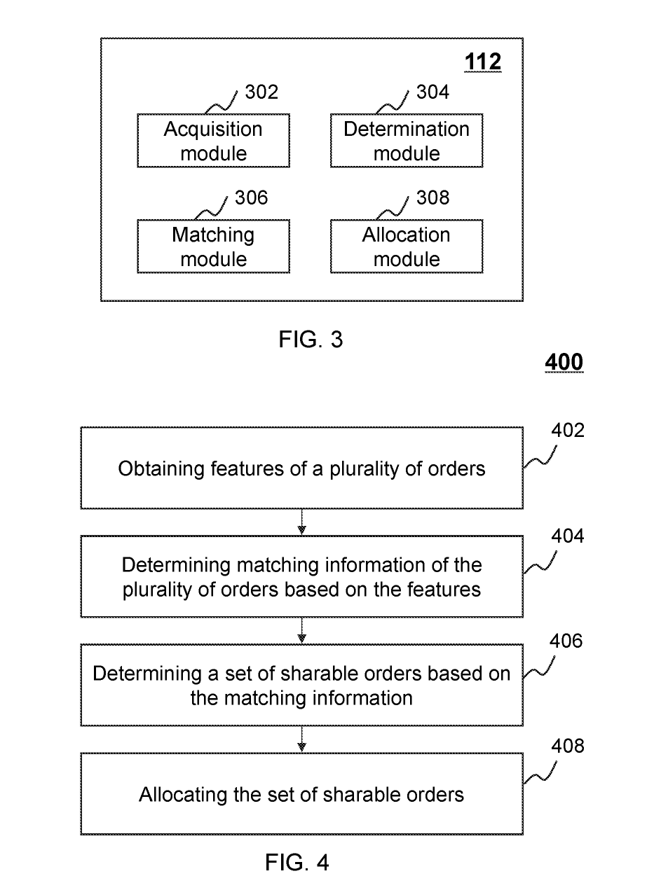

FIG. 3 is a block diagram illustrating an exemplary processing engine 112 according to some embodiments of the present disclosure. The processing engine 112 may include an acquisition module 302, a determination module 304, a matching module 306, and an allocation module 308.

The acquisition module 302 may be configured to obtain a plurality of orders from a plurality of requestors. As used herein, the system 100 may generate an order based on a request for an on-demand service sent by a requestor. It should be noted that in the disclosure there is no substantial difference between an order and a request.

The on-demand service may be a transportation service for a taxi, a private vehicle, a bus, a truck, a test drive, a designated driving, or the like, or a combination thereof. In some embodiments, the on-demand service may be any on-line service, such as booking a meal, shopping, or the like, or a combination thereof. In some embodiments, the requestor may choose whether to agree to share a service with other requestors in the on-demand service request. For example, the requestor may disagree to share a service with other requestors in any circumstances. As another example, the requestor may agree to share a service with other requestors under some situations (e.g., in traffic peak period).

The acquisition module 302 may obtain the plurality of orders from the requestor terminal 130 via the network 120. The acquisition module 302 may further obtain features (e.g., a start location, a destination) of the plurality of orders.

The determination module 304 may be configured to determine matching information of the plurality of orders based on the features. The determination module 304 may determine matching information between any two of the plurality of orders. The matching information may indicate whether the two orders may be sharable.

The matching module 306 may be configured to determine a set of sharable orders based on the matching information. As used herein, a sharable order may refer to an order that may be combined with other order(s). For example, if order A and order B include a similar start location or a similar destination, the matching module 306 may determine order A and order B as sharable orders. As used herein, a similar start location may refer to a start location of order A is reasonably close to a start location of order B for an ordinary person in the art. For example, if a distance between the start location of order A and the start location of order B is less than a threshold, such as 500 meters, 1 kilometer, or 1.5 kilometer, the system 100 may determine that the order A and order B include a similar start location. Likewise, the system may determine the similar destination in a similar way.

The allocation module 308 may allocate the set of sharable orders to service providers. For example, the allocation module 308 may combine two of the set of sharable orders as an order group and allocate the order group to a service provider (e.g., a driver).

The modules in the processing engine 112 may be connected to or communicate with each other via a wired connection or a wireless connection. The wired connection may include a metal cable, an optical cable, a hybrid cable, or the like, or any combination thereof. The wireless connection may include a Local Area Network (LAN), a Wide Area Network (WAN), a Bluetooth, a ZigBee, a Near Field Communication (NFC), or the like, or any combination thereof. Two or more of the modules may be combined as a single module, and any one of the modules may be divided into two or more units. For example, the acquisition module 302 may be integrated in the determination module 304 as a single module which may both obtain features of orders and determine matching information of the orders.

FIG. 4 is a flowchart illustrating an exemplary process/method 400 for allocating a set of sharable orders according to some embodiments of the present disclosure. The process and/or method 400 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 400.

In step 402, the processing engine 112 may obtain features of a plurality of orders. Each of the plurality of orders may be associated with a request of a transportation service. The processing engine 112 may determine the plurality of orders within a predefined region.

The predefined region may be an administrative area (e.g., a city, a district in a city), or a geographical region (e.g., within a certain radius from a defined center location).

The plurality of orders may include a real-time order, an appointment order, or a pending order. As used herein, a real-time order may be an order that the requestor wishes to get the service at the present moment or at a defined time reasonably close to the present moment for an ordinary person in the art. For example, an order may be a real-time order if the defined time is shorter than a threshold value, such as 1 minute, 5 minutes, 10 minutes or 20 minutes. The appointment order may refer to that the requestor wishes to get the service at a defined time which is reasonably far from the present moment for the ordinary person in the art. For example, an order may be an appointment order if the defined time is longer than a threshold value, such as 20 minutes, 2 hours, or 1 day. In some embodiments, the processing engine 112 may define the real-time order or the appointment order based on a time threshold. The time threshold may be default settings of the system 100, or may be adjustable depending on different situations. For example, in a traffic peak period, the time threshold may be relatively small (e.g., 10 minutes), otherwise in idle period (e.g., 10:00-12:00 am), the time threshold may be relatively large (e.g., 1 hour). The pending order may be an on-going order which is in progress by a service provider at the present moment.

The features of the plurality of orders may include basic route information, freight information, vehicle information, or the like, or a combination thereof. For a specific order, the basic route information may include a number of passengers, a start location, a destination, a mileage, a pick-up time, an estimated fee, a unit price (e.g., a unit price per kilometer or per mile), a congested portion of the route (e.g., a congested road due to traffic peak), or the like, or a combination thereof. The freight information may include a type of the freight (e.g., liquid or solid, fragile or non-fragile), a size (e.g., length, width, height), a volume, a weight, or the like, or a combination thereof. The vehicle information may include a number of seats in a vehicle, a trunk volume, a load capacity (i.e., a weight of products that the vehicle can carry), or the like, or a combination thereof. The processing engine 112 may define different values for different congestion situations. For example, the processing engine 112 may define three congestion levels indicating “heavy congestion,” “normal congestion,” and “mild congestion,”.

In some embodiments, the start location may be a current location of the requestor which may be obtained by the requestor terminal 130 (e.g., by a Global Position System (GPS) in the requestor terminal 130), or may be defined by the requestor. For example, the requestor may first login the online on-demand service system 100 via the requester terminal 130, and then may manually input the start location via the requestor terminal 130. As another example, the requestor may manually define the start location by identifying a geographic position (e.g., a bus station, a metro station, a crossroad, a landmark building) on a map (e.g., a Tencent Map, a Google Map) shown on the requestor terminal 130. As a further example, the requestor may scan a quick response (QR) code posted on the geographic position to define his/her current location.

In some embodiments, the pick-up time may be a current time when the requestor sends the service request, or may be defined by the requestor. For example, the requestor may manually input a time via the requestor terminal 130.

In step 404, the processing engine 112 may determine matching information of the plurality of orders based on the features.

The processing engine 112 may determine matching information between any two of the plurality of orders. The matching information may be associated with the features of two orders and may be used to determine whether the two orders may be sharable. For example, when the processing engine 112 obtains two orders, a first order and a second order, the first order corresponds to a first transportation service (e.g., a taxi service) and the second order corresponds to a second transportation service (e.g., a taxi service). The processing engine 112 may obtain features of the two orders, and then may determine matching information between the first order and the second order based on the first features and the second features. For example, the processing engine 112 may obtain features (i.e., the first features) of the first order of the first transportation service, such as a first start location, a first destination, a first driving route between the first start location and the first destination, and a first mileage of the first driving route. Similarly, the processing engine 112 may also obtain features (i.e., the second features) of the second order of the second transportation service, such as a second start location, a second destination, a second driving route between the second start location and the second destination, and a second mileage of the second driving route. The processing engine 112 may compare the first driving route and the second driving route to determine whether the two driving routes are combinable into a single combined driving route, so as to combine the first order and second order (i.e., the first order and the second order are “sharable.”). The processing engine 112 may also determine a combined mileage of the combined driving route based on the combination of the first order and the second order. The combined mileage may partially overlap with the first mileage or the second mileage. The combined mileage may include a shared mileage. As used herein, a shared mileage refers to a mileage under which the first transportation service and the second transportation service are both in progress.

In some embodiments, before the processing engine 112 determines the matching information of the plurality of orders, the processing engine 112 may determine whether the requestor wishes to share the service with other requestors (e.g., whether the requestor wishes to combine his/her driving route with that of another requestor.). The requestor may define whether he/she wishes to share a service with other requestors when he/she sends the request to the system 100. If the requestor doesn't wish to share the service other requestors, the processing engine 112 may allocate the order to service provider(s) directly.

In step 406, the processing engine 112 may determine a set of sharable orders based on the matching information. The processing engine 112 may determine the set of sharable orders by analyzing the matching information or the features of the plurality of orders. For example, as described in connection with step 404, if a percentage of the shared mileage in the combined mileage is larger than a predetermined threshold (e.g., 30%), it may indicate that the first order and the second order are sharable.

As another example, before the processing engine 112 compares the first driving route with the second driving route, the processing engine 112 may obtain a first number of passengers of the first order and a second number of passengers of the second order in step 402. In some embodiments, the processing engine 112 may determine whether the first number of passengers of the first order and the second number of passengers of the second order are both less than or equal to a predefined threshold (e.g., 2), if so, the processing engine 112 may determine that the first order and the second order are sharable; if not, the processing engine 112 may determine that the first order and the second order are not sharable. In some embodiments, the processing engine 112 may determine a total number of passengers based on the first number of passengers and the second number of passengers, and compare the total number of passengers with a number of seats (e.g., 3) of a candidate vehicle (e.g., an ordinary vehicle such as a car). If the total number of passengers is smaller than the number of seats of the candidate vehicle, the processing engine 112 may determine that the first order and the second order are sharable. In some embodiments, the processing engine 112 may first compare the total number of passengers with the number of seats of the candidate vehicle, if the number of passengers is larger than the number of seats of the candidate vehicle, the processing engine 112 may directly determine that the first order and the second order are not sharable.

As a further example, the processing engine 112 may obtain a first pick-up time of the first order and a second pick-up time of the second order. If a difference between the first pick-up time and the second pick-up time is less than a time threshold value (e.g., 30 minutes), the processing engine 112 may determine that the first order and the second order are sharable. In some embodiments, the processing engine 112 may determine the difference between the first pick-up time and the second pick-up time before the processing engine 112 compares the first driving route with the second driving route, if the difference between the first pick-up time and the second pick-up time is larger than the time threshold value, the processing engine 112 may directly determine that the first order and the second order are not sharable.

As a still further example, the first features or the second features may include freight information (e.g., first freight information, second freight information), that is, a first requestor of the first order or a second requestor of the second order includes a requirement for freight transportation. In this scenario, the processing engine 112 may match the first freight information and/or the second freight information with vehicle information, and then determine whether the first order and second order are sharable. For example, if the first order and the second order are real-time orders, the processing engine 112 may compare the first freight information and/or the second freight information (e.g., total size of the freights) with vehicle information (e.g., a truck volume) of a candidate vehicle (e.g., an ordinary vehicle such as a car or a lorry, or a vehicle specialized in freight transportation such as a van or a pickup.). If the total size of the freights is smaller than the truck volume of the vehicle, the processing engine 112 may determine that the first order and the second order are sharable. The vehicle information of an ordinary vehicle may be empirical information. The processing engine 112 may obtain the vehicle information of an ordinary vehicle from the database 150 or an external data source (e.g., a website, a cloud storage). For example, the database 150 may store vehicle information of common vehicle models. If the first order is a real-time order and the second order is a pending order, the processing engine 112 may further obtain second vehicle information of the second order and compare the first freight information with second vehicle information.

According to embodiments of the present disclosure, the first order and the second order may also be of different nature. For example, the first order may include a service request to transport a passenger, such as a taxi hailing, whereas the second order may include a service request to transport a freight, such as an express delivery calling. In this scenario, the processing engine 112 may match the first driving route and the second driving route to conclude that the two driving routes are combinable; and then may determine if the candidate vehicle has enough available passenger seats for the passenger and enough loading space for the freight. If the answer is yes, the processing engine 112 may determine that the first order and the second order are sharable, and send the two orders to the candidate vehicle.

In some embodiments, the processing engine 112 may jump through step 404 and determine the set of sharable orders according to time information (e.g., traffic peak period or idle period) or location information (e.g., an administrative area or a geographic region) of the orders it receives. For example, the processing engine 112 may predetermine an area (e.g., a central business district in a city where taxi service demand is substantially higher than supply) and/or a time period (e.g., 17:00-19:00 on workdays when taxi service demand is substantially higher than supply) for sharable orders. For any predetermined type of orders (e.g., real-time orders) sent during the predetermine time period and/or within the predetermined area, the processing engine 112 may directly determine categorize them as the set of sharable orders.

In step 408, the processing engine 112 may allocate the set of sharable orders. The processing engine 112 may allocate the set of sharable orders in a form of a combination including two sharable orders. For example, the processing engine 112 may combine two orders in the set of sharable orders into an order group and allocate the order group to a service provider. To this end, while allocating the set of sharable orders, the processing engine 112 may determine a plurality of relevance probabilities associated with the set of sharable orders. For example, the processing engine 112 may determine a relevance probability for any pair of two sharable orders in the set of sharable orders. Each relevance probability is a value indicating how “combinable” that the two sharable orders are. For example, a relevance probability may refer to a similarity between two sharable orders and/or may represent a profit value if the two sharable orders are combined. As used herein, a profit value may reflect service fee that the requestors of the two sharable orders may save, extra income that the service provider may obtain due to the combination of the two sharable orders, or the like. For example, the higher the relevance probability is, the more possible the combination of two sharable orders may be accepted by a service provider.

In some embodiments, the processing engine 112 may divide the set of sharable orders into multiple order groups. Each order group includes a pair of two sharable orders and each order group corresponds to a relevance probability between the pair of sharable orders. The processing engine 112 may determine the multiple order groups via a grouping method which maximizes a sum of the profit values corresponding to the multiple pair of shareable orders. The processing engine 112 may allocate the set of sharable orders based on the multiple order groups. For example, the processing engine 112 may send the order group to the provider terminal 140 of a service provider via the network 120.

In some embodiments, the processing engine 112 may determine and/or update the set of sharable orders periodically. For example, the processing engine 112 may determine and/or update the set of sharable orders according to a pre-determined time interval (e.g., 1 minute). If an order has been allocated, the processing engine 112 may delete the order from the set of sharable orders.

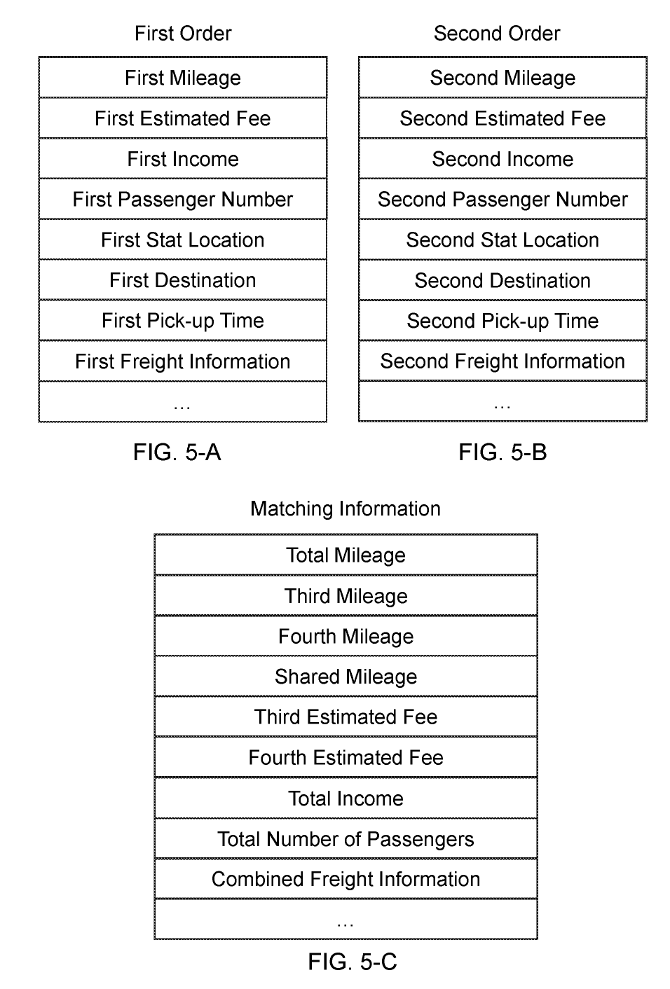

FIG. 5-A is an exemplary list illustrating first features of a first order, FIG. 5-B is an exemplary list illustrating second features of a second order, and FIG. 5-C is an exemplary list illustrating matching information of the first order and the second order.

As illustrated in FIG. 5-A, the first features of the first order may include a first mileage, a first estimated fee, a first income of a service provider if the service provider accepts the first order, a first number of passengers, a first start location, a first destination, a first pick-up time, first freight information, etc. As illustrated in FIG. 5-B, the second features of the second order may include a second mileage, a second estimated fee, a second income of a service provider if the service provider accepts the second order, a second number of passengers, a second start location, a second destination, a second pick-up time, second freight information, etc.

As described in connection with step 404, the processing engine 112 may determine matching information of the first order and the second order based on the first features and the second features. For example, the processing engine 112 may combine the first order and the second order (i.e., an order group including the first order and the second order) to determine a combined driving route. The processing engine 112 may determine the matching information of the first order and the second order based on the combined driving route. The matching information of the first order and the second order may include a total mileage, a third mileage of the first order, a fourth mileage of the second order, a shared mileage, a third estimated fee of the first order, a fourth estimated fee of the second order, a total income of a service provider if the service provider accepts the combination of the first order and the second order, a total number of passengers, combined freight information, etc. As used herein, the total mileage may refer to a mileage of the combined driving route. The third mileage of the first order may refer to a mileage in the combined driving route to fulfill the transportation service required in the first order. The fourth mileage of the second order may refer to a mileage in the combined driving route to fulfill the transportation service required in the second order. The shared mileage may refer to a mileage in the combined route under which the first transportation service and the second transportation are both in progress. The third estimated fee of the first order may refer to a service fee that the first requestor needs to pay for the first transportation service if the service provider servers it by the combination of the first order and the second order. The fourth estimated fee of the second order may refer to a service fee that the second requestor needs to pay for the second transportation service if the service provider servers it by the combination of the first order and the second order.

In some embodiments, the processing engine 112 may determine the third estimated fee of the first order or the fourth estimated fee of the second order based on a predetermined unit price (e.g., a predetermined unit price per kilometer or per mile). For example, the predetermined unit price may be a standard price per kilometer to calculate a fee that a passenger need to pay for a taxi service if a taxi only serves the passenger without combining the service with other passengers. For the first order in normal mode, the processing engine 112 may determine the first estimated fee based on a normal unit price P; whereas for the combination of the first order and the second order, the processing engine 112 may determine the third estimated fee of the first order based on a modified unit price a*P. Here a is a positive number less than 1. In some embodiments, the processing engine 112 may determine the third estimated fee of the first order or the fourth estimated fee of the second order based on a discount for sharable orders. For example, for the first order in normal mode, the first estimated fee may be F; whereas for the combination of the first order and the second order, the processing engine 112 may determine the third estimated fee of the first order as b*F. Here, b is a positive number less than 1.

The processing engine 112 may further determine a first distance between the first start location and the second start location or a second distance between the first destination and the second destination. The processing engine 112 may further determine a difference between the first pick-up time and the second pick-up time. The processing engine 112 may further determine combined freight information based on the first freight information and the second freight information. For example, the processing engine 112 may determine a total size of the first freight and the second freight. The processing engine 112 may further determine first vehicle information or second vehicle information (not shown in FIGS. 5-A through 5-C). For example, for a pending order, the pending order corresponds to a vehicle, the processing engine 112 may determine a remaining truck volume of the vehicle.

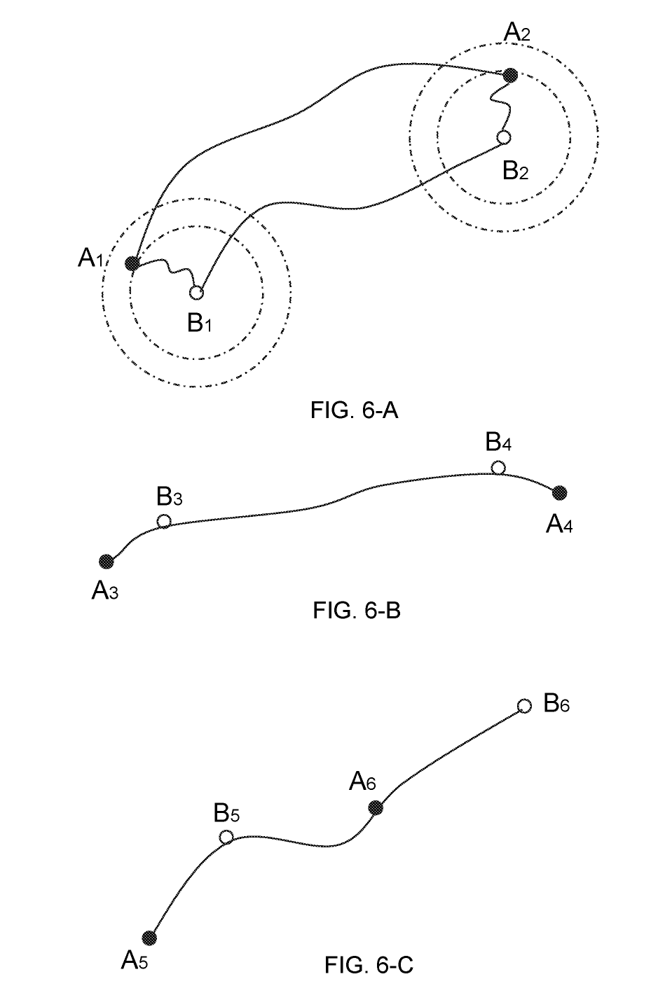

FIG. 6-A through FIG. 6-C are schematic diagrams illustrating an exemplary process/method for determining the set of sharable orders according to some embodiments of the present disclosure. The illustration takes two transportation services as an example, and starts from when the processing engine 112 has obtained the first order and the second order, as described in connection with FIGS. 5-A through 5-C and the description thereof.

As illustrated in FIG. 6-A, A₁ refers to the first start location, and A₂ refers to the first destination. B₁ refers to the second start location, and B₂ refers to the second destination. The processing engine 112 may determine whether the first order and the second order are sharable based on the first distance between the first start location A₁ and the second start location B₁ and/or the second distance between the first destination A₂ and the second destination B₂. For example, if the first distance between A₁ and B₁ is less than a distance threshold (e.g., 1 km) and/or the second distance between A₂ and B₂ is less than a distance threshold (e.g., 1 km), the processing engine 112 may determine that the first order and the second order are sharable.

As illustrated in FIG. 6-B, A₃ refers to the first start location, and A₄ refer to the first destination. B₃ refers to the second start location, and B₄ refer to the second destination. The processing engine 112 may determine whether the first order and the second order are sharable based on a first route of the first order and a second route of the second order. As illustrated, a path from A₃ to A₄ refers to the first route, a path from B₃ to B₄ refers to the second route. For example, if the first route partially overlaps with the second route and a percentage of the overlapping part (e.g., the path from B₃ to B₄) in the total route (e.g., the path from A₃ to A₄) is larger than a percentage threshold (e.g., 90%), the processing engine 112 may determine that the first order and the second order are sharable.

As illustrated in FIG. 6-C, A₅ refers to the first start location, and A₆ refers to the first destination. B₅ refers to the second start location, and B₆ refer to the second destination. The processing engine 112 may determine the first mileage (e.g., a distance from A₅ to A₆) and the second mileage (e.g., a distance from B₅ to B₆). The processing engine 112 may further determine a combined driving route for a combination of the first order and the second order, for example, a path illustrated as A₅→B₅→A₆→B₆. The processing engine 112 may determine a total mileage for the combination of the first order and the second order based on the combined driving route (e.g., a distance from A₅ to B₆). It should be noted that “distance” used in this disclosure may refer to a spatial distance or a travel distance. As used herein, a spatial distance may refer to a distance of a path along which a service provider can drive a vehicle, such as a portion of road or a street. The processing engine 112 may determine whether the first order and the second order are sharable based on the first mileage, the second mileage, and the total mileage. For example, if a shared mileage (e.g., a distance from B₅ to A₆) is larger than a predetermined threshold (e.g., a distance corresponding to a starting price (e.g., 3 km)), the processing engine 112 may determine that the first order and the second order are sharable. As another example, if a percentage of the first mileage or the second mileage in the total mileage is larger than a predetermined threshold value (e.g., 40%), the processing engine 112 may determine that the first order and the second order are sharable. As a further example, if a percentage of the shared mileage in the third mileage or the fourth mileage is larger than a predetermined threshold value (e.g., 30%), the processing engine 112 may determine that the first order and the second order are sharable. As a still further example, if the total mileage is less than a predetermined multiple (1.5 times) of the third mileage or the fourth mileage, the processing engine 112 may determine that the first order and the second order are sharable.

In some embodiments, as described in connection with FIGS. 5-A through 5-C and the description thereof, the processing engine 112 may determine whether the first order and the second order are sharable based on the first estimated fee, the second estimated fee, the third estimated fee, and/or the fourth estimated fee. For example, if the third estimated fee is less than the first estimated fee and/or the fourth estimated fee is less than the second estimated fee, the processing engine 112 may determine that the first order and the second order are sharable. As another example, if the total income of a service provider of the combination of the first order and the second order is larger than a predetermine threshold value (e.g., a normal income of a normal order from A₅ to B₆), the processing engine 112 may determine that the first order and the second order are sharable. As a further example, if a unit income (e.g., a unit income per kilometer or per mile) of the service provider of the total mileage is larger than a normal unit income of a mileage from A₅ to B₆, the processing engine 112 may determine that the first order and the second order are sharable.

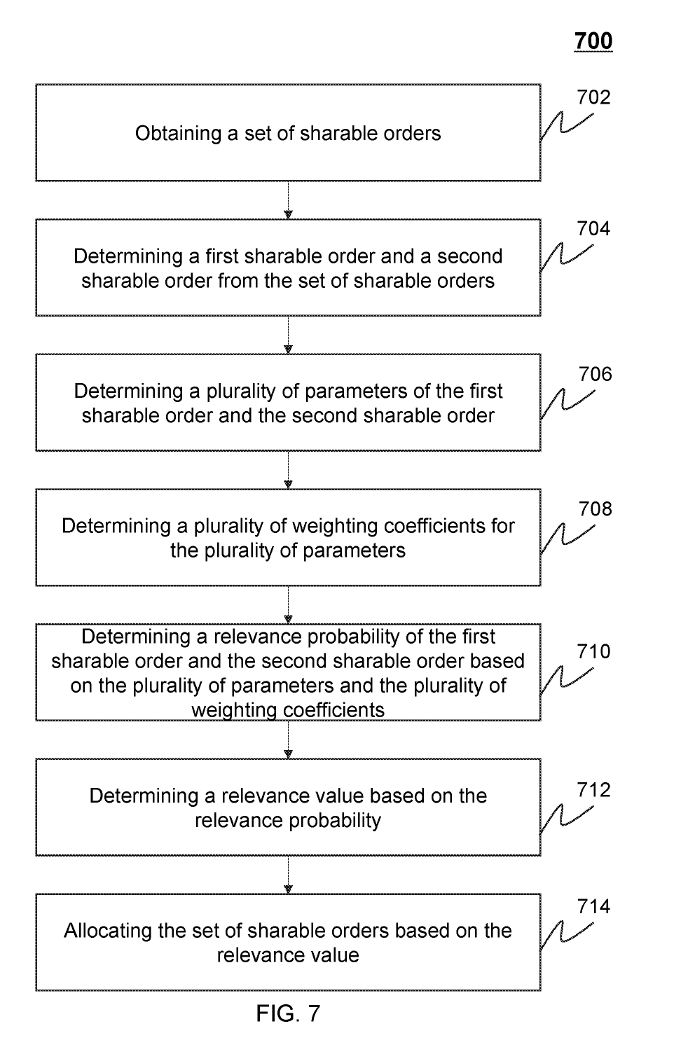

FIG. 7 is a flowchart illustrating an exemplary process/method 700 for allocating the set of sharable orders according to some embodiments of the present disclosure. The process and/or method 700 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 700.

In 702, the processing engine 112 may obtain a set of sharable orders. As described in connection with FIG. 4, the processing engine 112 may determine the set of sharable orders based on the matching information of a plurality of orders.

In step 704, the processing engine 112 may determine a first sharable order and a second sharable order from the set of sharable orders. The processing engine 112 may determine the first sharable order and the second sharable order randomly from the set of sharable orders.

In step 706, the processing engine 112 may determine a plurality of parameters of the first sharable order and the second sharable order. The processing engine 112 may determine the plurality of parameters based on the features and/or the matching information of the first sharable order and the second sharable order. The plurality of parameters may be associated with a similarity between the first sharable order and the second sharable order. The higher the similarity is, the higher the probability that a service provider may accept a combined order of the two sharable orders.

In step 708, the processing engine 112 may determine a plurality of weighting coefficients for the plurality of parameters. The plurality of weighting coefficients may reflect an influence level on the acceptance of the combination of the two sharable orders by a service provider. For convenience and illustration purposes, as described in connection with FIGS. 5-A through 5-C, Table 1 below illustrates the plurality of parameters and the corresponding plurality of weighting coefficients.

TABLE 1
a schematic table illustrating exemplary parameters and
corresponding weighting coefficients

| | Positive/ | Influence | Weighting |
|---|---|---|---|
| Parameter | Negative | level | coefficient |
| First fee-saving ratio * Second fee- | Positive | High | 1 |
| saving ratio | | | |
| Ratio of an extra income of a service | Positive | High | 1 |
| provider | | | |
| Unit income of a combination of the | Positive | Low | 0.2 |
| first sharable order and the second | | | |
| sharable order/unit income of the first | | | |
| sharable order and the second | | | |
| sharable order | | | |
| (first saved fee/first detour mileage) * | Positive | Medium | 0.5 |
| (second saved fee/second detour | | | |
| mileage) | | | |
| Shared mileage/total mileage | Positive | High | 0.8 |
| First detour mileage | Negative | Relatively | −0.6 |
| | | high | |
| Second detour mileage | Negative | Relatively | −0.6 |
| | | high | |
| First percentage of the shared mileage | Positive | Relatively | 0.6 |
| in the third mileage * Second | | high | |
| percentage of the shared mileage in | | | |
| the fourth mileage | | | |

As used herein, the first fee-saving ratio may refer to a ratio illustrated below:

$$\frac{( the first estimated fee - the third estimated fee )}{the first estimated fee} .$$

Similarly, the second fee-saving ratio may refer to a ratio illustrated below:

$$\frac{( the second estimated fee - the fourth estimated fee )}{the second estimated fee} .$$

The ratio of the extra income of a service provider may refer to a ratio illustrated below:

$$\frac{( the total income - a normal income )}{the normal income} ,$$

where the normal income refers to an income of a service provider based on a normal order including a same mileage or a same driving route with the combination of the first sharable order and the second sharable order.
The first saved fee may refer to a difference between the first estimated fee and the third estimated fee illustrated below:

(the first estimated fee−the third estimated fee).

The first detour mileage may refer to a difference between the first mileage and the third mileage illustrated below:

(the first mileage−the third mileage).

The second saved fee may refer to a difference between the second estimated fee and the fourth estimated fee illustrated below:

(the second estimated fee−the fourth estimated fee).

The second detour mileage may refer to a difference between the second mileage and the fourth mileage illustrated below:

(the second mileage−the fourth mileage).

As illustrated in Table 1, “positive” and “negative” refer to a positive influence and a negative influence on the similarity between the two sharable orders respectively. An absolute value of a weighting coefficient represents an influence level of a corresponding parameter, the higher the absolute value of a weighting coefficient is, the higher the influence level of the corresponding parameter upon the similarity between the two sharable orders. For example, as illustrated in Table 1, the weight coefficients of the parameters “first fee-saving ratio * second fee-saving ratio” and “ratio of extra income of a service provider” are both 1, it indicates that the influence levels of the two parameters upon the similarity between the two sharable orders are reasonably high.

In step 710, the processing engine 112 may determine a relevance probability of the first sharable order and the second sharable order based on the plurality of parameters and the plurality of weighting coefficients. In some embodiments, as described in connection with step 408, the relevance probability may represent a profit value of a pair of sharable orders. For example, as mentioned above, the profit value may be expressed as formula (1) below:

$$V = \frac{( the first estimated fee - the third estimated fee )}{the first estimated fee} * \frac{( the second estimated fee - the fourth estimated fee )}{the second estimated fee} * {w}_{1} + \frac{( the total income - the normal income )}{the normal income} * {w}_{2} \qquad ( 1 )$$

where V refers to the profit value, w₁ refers to a weighting coefficient of the parameter “first fee-saving ratio * second fee-saving ratio”, and w₂ refers to the weighting coefficient of the parameter “ratio of extra income of a service provider”. In this situation, the values of w₁ and w₂ are both 1. It should be noted that formula (1) is only provided for illustration purposes, the profit value may be expressed as other forms, for example, formula (2) below:

$$V = \frac{( the first estimated fee - the third estimated fee )}{the first estimated fee} * {w}_{1} + \frac{( the second estimated fee - the fourth estimated fee )}{the second estimated fee} * {w}_{1} + \frac{( the total income - the normal income )}{the normal income} * {w}_{2} \qquad ( 2 )$$

In some embodiments, the processing engine 112 may determine the relevance probability according to a sigmoid function. For example, the sigmoid function may be expressed as formula (3) below:

$${P}_{ij} = \frac{1}{1 + {e}^{- W * X + b}} \qquad ( 3 )$$

where Pᵢⱼ refers to the relevance probability of a sharable order i (also referred to as an ith sharable order) and a sharable order j (also referred to as a jth sharable order), W refers to a set {w₁, w₂, . . . , wₙ} including the plurality of weighting coefficients, X refers to a set {x₁, x₂, . . . , xₙ} including the plurality of parameters, W*X refers to “w₁*x₁+w₂*x₂+ . . . +wₙ*xₙ”, and b is a constant (e.g., an empirical value). It may be seen from formula (3) that the relevance probability may be within a range (0, 1).

For example, if only taking the profit value into consideration, the relevance probability may be expressed as formula (4) below:

$${P}_{ij} = \frac{1}{1 + {e}^{- {V}_{ij} + b}} \qquad ( 4 )$$

where Vᵢⱼ refers to a profit value of a combination of order i and order j. In some embodiments, the profit value may be defined as W*X. In this situation, formula (4) and formula (3) are identical.

In some embodiments, the processing engine 112 may determine the plurality of weighting coefficients based on default settings of the system 100. In some embodiments, the processing engine 112 may determine the plurality of weighting coefficients based on a machine learning model. The machine learning model may be a logistic regression model. The processing engine 112 may train historical data relating to the first sharable order and the second sharable order, and determine the plurality of weighting coefficients based on the historical data.

For example, the processing engine 112 may determine a likelihood function of a sample space according to formula (5) below, for the sample space, the element is yᵢⱼ, that is, the sample space represents whether the processing engine 112 combines the order i and the order j as an order group.

L=ΠPᵢⱼ^{y}^{ᵢⱼ}*(1−Pᵢⱼ)^{1-y}^{ᵢⱼ} (5)

where L refers to the likelihood function, and yᵢⱼ refers to whether the processing engine 112 may combine the order i and the order j as an order group, if so, the value of yᵢⱼ is 1, if not, the value of yᵢⱼ is 0.

The processing engine 112 may determine a maximum likelihood function of the sample space by a logarithmic algorithm according to formula (6) below:

M=MAX{Σyᵢⱼ*Log(Pᵢⱼ)+Σ(1−yᵢⱼ)* log(1−Pᵢⱼ)} (6)

where M refers to the maximum likelihood function. The maximum likelihood function may correspond to a suitable sample space (e.g., a most probable sample space). When the processing engine 112 determines the maximum likelihood function, the processing engine 112 may determine the suitable sample space. The processing engine 112 may further determine the plurality of weighting coefficients based on the suitable sample space.

In some embodiments, the processing engine 112 may determine a plurality of relevance probabilities of the set of sharable orders in a similar way with that of the first sharable order and the second sharable order, and each of the plurality of relevance probabilities corresponds to two sharable orders in the set of sharable orders. For example, the processing engine 112 may determine a relevance matrix illustrated below:

$$P = [ \begin{matrix}{P}_{11} & … & {P}_{1 n} \\ ⋮ & ⋱ & ⋮ \\ {P}_{n 1} & … & {P}_{nn}\end{matrix} ] \qquad ( 7 )$$

where P refers to the relevance matrix, n refers to a total number of sharable orders in the set of sharable orders, and Pᵢⱼ refers to the relevance probability between the ith sharable order and the jth sharable order.

In step 712, the processing engine 112 may determine a relevance value based on the relevance probability. For example, for the first sharable order (e.g., order i) and the second sharable order (e.g., order j), the processing engine 112 may determine the relevance value according to formula (8) below:

R=Pᵢⱼ*dᵢⱼ (8)

where R refers to the relevance value, and dᵢⱼ refers to whether the processing engine 112 may combine the order i and the order j as an order group, if so, the value of dᵢⱼ is 1, if not, the value of dᵢⱼ is 0.

In some embodiments, the processing engine 112 may determine a global relevance value according to formula (9) below:

E=Σ_{i=1,j=1}ⁿPᵢⱼ*dᵢⱼ (9)

where E refers to the global relevance value, which indicates an overall relevance probability for the set of sharable orders when the set of sharable orders is combined under the arrangement defined by a combination matrix below:

$$D = [ \begin{matrix}{d}_{11} & … & {d}_{1 n} \\ ⋮ & ⋱ & ⋮ \\ {d}_{n 1} & … & {d}_{nn}\end{matrix} ] \qquad ( 10 )$$

where D refers to the combination matrix, defining which two sharable orders should be combined, and where

∀i, Σⱼ₌₁ⁿdᵢⱼ=1; ∀j, Σᵢ₌₁ⁿd=1. (11)

In step 714, the processing engine 112 may allocate the set of sharable orders based on the relevance value. The processing engine 112 may define the combination matrix for the set of sharable orders according to formula (10).

Further, the processing engine 112 may determine and/or figure out a combination matrix D which results in a maximum global relevance. The processing engine 112 may allocate the set of sharable orders based on the combination matrix D. In some embodiments, in order to determine the combination matrix D which results in a maximum global relevance, the processing engine 112 may traverse all the sharable orders in the set of sharable orders. In some situations, if a sharable order i has the largest relevance probability value with a sharable order j than with any other sharable orders in the relevance matrix, the processing engine 112 may determine the value of dᵢⱼ as 1, that is, the processing engine 112 may determine that the specific order i and the order j can be combined as an order group. In some situations, if for the sharable order i, a relevance probability value with a sharable order x and a relevance probability value with a sharable order y are the same and the two relevance probabilities both are largest than with any other sharable orders in the relevance matrix, the processing engine 112 may select the sharable order x or the sharable order y, and determine the value of dᵢₓ, or d_{iy} as 1. In some situations, for the sharable order i, the processing engine 112 may select a sharable order z other than the orders i, x, and y, and determine the value of d_{iz}, as 1.

The processing engine 112 may determine the combination matrix D by traversing all the sharable orders in the set of sharable orders. According to the determined combination matrix D, the global relevance value is maximum, whereas for a specific order i, the processing engine 112 may determine an order o to combine with the order i, and the relevance probability with the order o may or may not be maximum than with any other sharable orders in the relevance matrix.

In some embodiments, the processing engine 112 may determine the combination matrix D based on a hill-climbing algorithm, a genetic algorithm, a simulated annealing algorithm, or the like, or a combination thereof.

Take the hill-climbing algorithm as an example, the hill-climbing algorithm may be a local optimization algorithm. For illustration purposes, in the hill-climbing algorithm, there may be a plurality of nodes, the processing engine 112 may select a specific node and compare the value of the specific node (e.g., a topological potential value) with the values of neighboring nodes, if the comparison result indicates that the value of the specific node is maximum, the processing engine 112 may determine the value of the specific node as the maximum value, that is, the processing engine 112 may determine the specific node as a peak of the hill; whereas the processing engine 112 may select a neighboring node whose value is maximum and repeat the above process.

The processing engine 112 may allocate the set of sharable orders according to the hill-climbing algorithm, the processing engine 112 may determine a first combination matrix for the set of sharable orders. The first combination matrix indicates a plurality of combinations of sharable orders, and each of the plurality of combinations includes two sharable orders. The processing engine 112 may determine a first global relevance based on the first combination matrix. In some embodiments, the processing engine 112 may determine the first combination matrix based on default settings of the system 100. In some embodiments, the processing engine 112 may traverse all the sharable orders in the set of sharable orders and determine a combination parameter for each sharable order in the set of sharable orders. For example, it may be supposed that the set of sharable orders includes an order 1, an order 2, . . . , and an order m. According to the first combination matrix, for a specific order i, the processing engine 112 may have combined order j with order i (which may be expressed as a combination (i, j)). The processing engine 112 may determine a first set including the sharable orders other than order i and order j.

Further, for an order s in the first set, according to the first combination matrix, the processing engine 112 may have combined order s with order t (which may be expressed as a combination (s, t)). The processing engine 112 may determine a first relevance value based on the two combinations (i, j) and (s, t). The processing engine 112 may further determine a second combination matrix which may indicate a modification of the plurality of combinations. For example, the processing engine 112 may modify the two combinations (i, j) and (s, t) as (s, i) and (i, t) or (s, i), (i, p) and (q, t). The processing engine 112 may determine a second relevance value based on the above modified combinations.

The processing engine 112 may determine whether the second relevance value is larger than the first relevance value, if so, the processing engine 112 may replace the first combination matrix by the second combination matrix; if not, the processing engine 112 may select another order in the first set and repeat the above process. The processing engine 112 may terminate the hill-climbing step until all the sharable orders in the first set are traversed. When the processing engine 112 terminates the hill-climbing step, the processing engine 112 may determine a second global relevance value based on the final modified combination matrix. The processing engine 112 may determine whether the second global relevance is larger than the first global relevance, if so, the processing engine 112 may return to select another sharable order in the set of sharable orders and perform another hill-climbing step; if not, the processing engine 112 may terminate the hill-climbing process and output the first combination matrix.

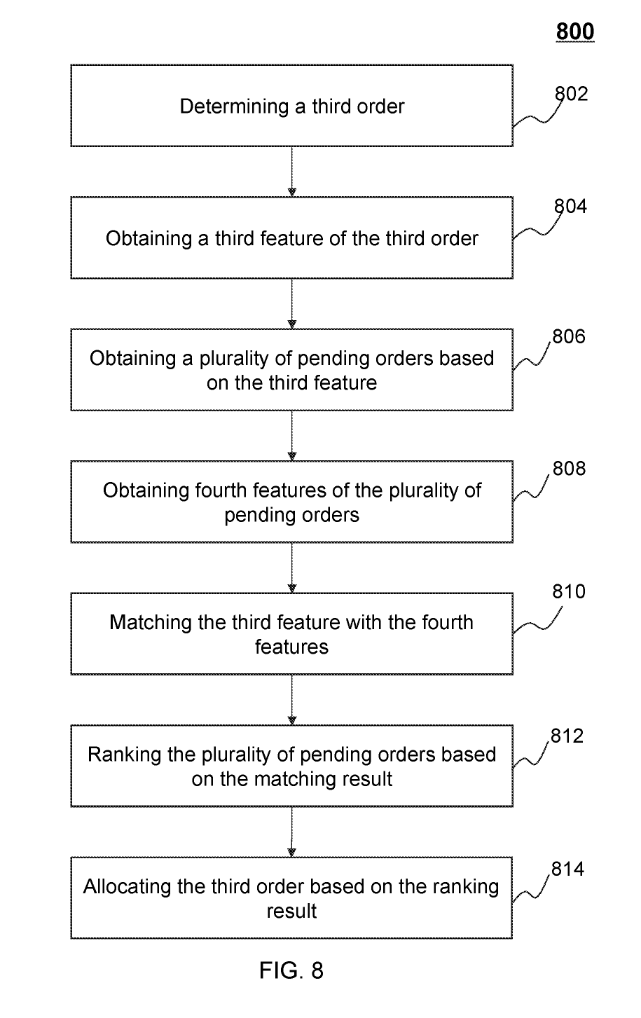

FIG. 8 is a flowchart illustrating an exemplary process/method 800 for allocating a real-time order according to some embodiments of the present disclosure. The process and/or method 800 may be executed by the on-demand service system 100. For example, the process and/or method may be implemented as a set of instructions (e.g., an application) stored in the storage ROM 230 or RAM 240. The CPU 210 may execute the set of instructions and may accordingly be directed to perform the process and/or method 800.

In step 802, the processing engine 112 may determine a third order from a requestor. The processing engine 112 may determine the third order based on a request sent by a requestor via the requestor terminal 130. The third order may be a real-time order or an appointment order. The request may be a request for freight transportation service.

In step 804, the processing engine 112 may obtain a third feature of the third order. The third feature of the third order may include a third number of passengers, a third start location, a third pick-up time, a third destination, third freight information, additional information, or the like, or a combination thereof. The third freight information may include a type of the freight, a size of the freight (e.g., length, width, height), a weight of the freight, or the like, or a combination thereof. The freight information may further include a remark relating to the freight. For example, the requestor may add a remark to show that the freight can't stand much weight or the freight may be fragile. The additional information may be information relating to additional requirements defined by the requestor. For example, the requestor may define a waiting time duration that the requestor can bear. In some embodiments, the processing engine 112 may provide a notification to the requestor to notify the requestor to pack the freight in advance.

In some embodiments, the processing engine 112 may further estimate a service fee based on the third feature of the third order and notify the estimated fee to the requestor. The requestor may send a request for modifying the service fee. For example, the requestor may request to add a tip (e.g., 5 dollars). The value of the tip may be default settings of the on-demand system 100, or may be adjusted by the requestor.

In step 806, the processing engine 112 may obtain a plurality of pending orders based on the third feature. The pending order refers to an on-going order which in progress by a service provider at the present moment. The processing engine 112 may obtain the plurality of pending orders within a predetermined distance from the third start location. The predetermined distance may be default settings of the system 100, or may be adjustable depending on different situations. For example, in traffic peak period, the predetermined distance may be relatively small (e.g., 1 km), otherwise in idle period (e.g., 10:00-12:00 am), the predetermined distance may be relatively large (e.g., 3 km). As another example, if the third start location is in a highly populated area (e.g., Manhattan of New York City), or the number of requestors or service providers registered with the on-demand service system 100 and appeared in the area is larger than a threshold (e.g., 60 thousands), the predetermined distance may be relatively small (e.g., 1 km), whereas the predetermined distance may be relatively large (e.g., 3 km). if the third start location is in a less populated area (e.g., a rural area), or the number of requestors or service providers registered with the on-demand service system 100 in the area is smaller than a threshold (10 thousands). As a further example, if the third start location is on a road where a number of traffic lights is larger than a threshold (e.g., 5), the predetermined distance may be relatively small (e.g., 1 km), whereas the predetermined distance may be relatively large (e.g., 3 km) if the third start location is on a road where the number of traffic lights is less than the threshold.

In step 808, the processing engine 112 may obtain fourth features of the plurality of pending orders. For each of the plurality of pending orders, the fourth feature may include a location of a provider/vehicle of the pending order, a fourth route, fourth vehicle information, fourth freight information, or the like, or a combination thereof. The processing engine 112 may determine the location of the provider/vehicle of the pending order via a GPS in the provider terminal 140 or a driving recorder in the vehicle. The fourth vehicle information may include a fourth number of seats in the vehicle, a fourth number of passengers, a truck volume, a load capacity, or the like, or a combination thereof. The processing engine 112 may further determine a remaining truck volume based on the fourth vehicle information and the fourth freight information. For example, for a specific pending order, if a volume of the freight is V₁, the truck volume of the vehicle is V₀, the remaining truck volume may be (V₀-V₁).

In some embodiments, the processing engine 112 may obtain the fourth features by analyzing registration of corresponding providers. For example, when a provider registers with the on-demand service system 100, the system 100 may require him/her to provide registration information associated with the vehicle. The provider may manually input (e.g., by text input or by voice input) the registration information (e.g., type, model, brand, plate number) via the provider terminal 140. The processing engine 112 may determine the vehicle information by analyzing the registration information. For example, a specific model may correspond to a specific truck volume.

In step 810, the processing engine 112 may match the third feature with the fourth features. In some embodiments, for a specific pending order of the plurality of pending orders, the processing engine 112 may match the fourth vehicle information with the third freight information. For example, the processing engine 112 may determine an available truck volume based on a volume coefficient c (e.g., 0.6). The volume coefficient may represent an availability degree of the remaining truck volume of the vehicle. For example, if the remaining truck volume is Vₐ, the available truck volume is c* Vₐ. The processing engine 112 may determine whether the available truck volume is larger than the size of the freight. If so, the processing engine 112 may determine that the third feature matches the fourth feature; if not, the processing engine 112 may determine that the third feature does not match the fourth feature. The volume coefficient may be default settings of the system 100 or may be adjustable under different situations. For example, different vehicle models may correspond to different volume coefficients. The processing engine 112 may match each of the plurality of pending orders with the third order and determine a plurality of candidate pending orders which matches the third order.

In step 812, the processing engine 112 may rank the plurality of candidate pending orders based on the matching result. The plurality of candidate pending orders may correspond to a plurality of candidate providers. Therefore, as used herein, “rank the plurality of candidate pending orders” refers to “rank the plurality of candidate providers”.

In some embodiments, for each of the plurality of candidate pending orders, the processing engine 112 may further match the third start location and/or the third destination with the fourth route. For example, the processing engine 112 may determine a third route between the third start location and the third destination, and compare the third route with the fourth route. The third route may partially overlap with the fourth route, and the processing engine 112 may determine a percentage of the overlapping part in the third route or the fourth route. The processing engine 112 may further determine a plurality of percentages of overlapping part for the plurality of candidate pending orders, rank the plurality of candidate providers based on the plurality of percentages, and generate a first ranking result, for example, from large to small.

In some embodiments, the processing engine 112 may determine a plurality of distances between the plurality of candidate providers and the third start location, and one of the plurality distances corresponds to one of the candidate providers. The processing engine 112 may rank the candidate providers based on the plurality of distances and generate a second ranking result.

In some embodiments, the processing engine 112 may combine the first ranking result and the second ranking result to generate a third ranking result. When combining the ranking results, the processing engine 112 may assign different weighting coefficients to the first ranking result and the second ranking result, and generate the third ranking result based on the weighting coefficients.

Merely by way of example, as illustrated in Table 2 below, if the weighting coefficient for the first ranking result is 0.6, and the weighting coefficient for the second ranking result is 0.4, the processing engine 112 may determine third ranking values based on the weighting coefficients, and then, the processing engine 112 may determine the third ranking result based on the third ranking values.

TABLE 2
a schematic table illustrating an exemplary combined ranking result

| Pending | First ranking | Second | Third ranking | Third ranking |
|---|---|---|---|---|
| order | result | ranking result | value | result |
| A | 1 | 5 | 2.4 | 3 |
| B | 2 | 1 | 1.2 | 1 |
| C | 3 | 2 | 2 | 2 |
| D | 4 | 3 | 2.8 | 4 |
| E | 5 | 4 | 3.6 | 5 |

In some embodiments, in step 806, the processing engine 112 may also determine a plurality of available providers within a predetermined distance from the third start location. As used herein, an available provider refers to a service provider who can provide the required service at the present moment, and for the service provider, he/she is not providing service for other requestors at the present moment. An available provider may correspond to an available vehicle. The processing engine 112 may determine the remaining truck volumes of the available vehicles, determine the available truck volumes based on the remaining truck volumes, and match the available vehicles with the third freight information. The processing engine 112 may further determine candidate providers corresponding to the available vehicles which match the third freight information. As used herein, for an available vehicle, the remaining truck volume refers to an original truck volume of the vehicle or a defined truck volume by the corresponding available provider.

In some embodiments, when determining the fourth features, for each of the plurality of pending orders, the processing engine 112 may determine whether the requestor of the pending order wishes to share the vehicle with other requestors. The requestor may define that he/she doesn't wish to share a vehicle with other requestors when he/she sends a request or when the processing engine 112 sends a notification to his/her requestor terminal 130.

In step 814, the processing engine 112 may allocate the third order based on the first ranking result, the second ranking result, or the third ranking result. For example, the processing engine 112 may send the third order to the first N candidate providers correspond to first N candidate pending orders (e.g., 3) according to the third ranking result, where N is a positive integer. As another example, the processing engine 112 may predetermine a distance threshold (e.g., 5 km) and send the third order to first N′ candidate providers corresponding to first N′ candidate pending orders within the distance threshold from the third start location according to the second ranking result.

In some embodiments, before or after the processing engine 112 matches the third freight information with the fourth vehicle information, for each of the plurality of pending orders, the processing engine 112 may determine an available number of seats in the vehicle and compare the third number of passengers with the available number of seats in the vehicle. The processing engine 112 may determine the available number of seats based on the fourth number of seats in the vehicle and the fourth number of passengers of the pending order. If the third number of passengers is larger than the available number of seats in the vehicle, the processing engine 112 may directly determine that the third feature does not match the fourth feature.

In some embodiments, in step 810, the processing engine 112 may both match the third freight information with the fourth vehicle and the third route with the fourth route, and determine the plurality of candidate pending orders based on the matching result. In this scenario, the processing engine 112 may further rank the plurality of candidate providers based on the distances between the plurality of providers and the third start location, and allocate the third order to the plurality of candidate providers based on the ranking result.

Merely by way of example, a requestor A wishes to transport a basket of fruits from a start location A to a destination A. The requestor A may send a transportation request to the on-demand service system 100 via the requestor terminal 130. The length, width, and height of the basket are 0.2 m, 0.3 m, and 0.4 m respectively. The volume of the basket is 0.024 m³. The processing engine 112 may obtain the start location A, the destination A, and the volume of the basket from the requestor terminal 130 via the network 120. The processing engine 112 may further estimate a service fee and generate an order A based on the transportation request. Further, the processing engine 112 may determine 4 vehicles including B, C, D, and E within a predetermined distance (e.g., 1 km) from the start location A.

The processing engine 112 may determine truck information and distance information of the 4 vehicles illustrated in Table 3. If the vehicle corresponds to a pending order, the processing engine 112 may further determine whether a corresponding requestor wishes to share the vehicle with other requestors.

TABLE 3
a table illustrating exemplary information relating to the vehicles

| | Remaining | Available | | Pending or | Sharable |
|---|---|---|---|---|---|
| Vehicle | truck volume | truck volume | Distance | not | or not |
| B | 0.21 | 0.126 | 200 | No | N/A |
| C | 0.03 | 0.018 | 300 | No | N/A |
| D | 0.21 | 0.126 | 500 | Yes | No |
| E | 0.21 | 0.126 | 800 | Yes | Yes |

The processing engine 112 may determine that the vehicle B and the vehicle E match the order A. In some embodiments, the processing engine 112 may allocate the order A to a provider B corresponding to the vehicle B, if the provider B rejects to accept the order A, the processing engine 112 may further allocate the order A to a provider E corresponding to the vehicle E. In some embodiments, the processing engine 112 may allocate the order A to the provider B and the provider E simultaneously, and the provider B and the provider E may choose to accept the order A or not.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “unit,” “module,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

1. A system, comprising:
a signal transmission port of a service request system to obtain electronic signals including a plurality of orders from a network associated with a service from a plurality of service receivers in the service request system, each order associated with a request of a service and including a plurality of features;
a second signal transmission port of a service providing system including a plurality of service providers;
a bus;
one or more storage media electronically connected to the bus, comprising a set of instructions for allocating a plurality of orders; and
logic circuits electronically connected to the one or more storage media via the bus, wherein during operation, the logic circuits load the set of instructions and;
obtain the electronic signals from the bus, the electronic signals including the plurality of orders;
determine matching information of the plurality of orders based on the features of the plurality of orders;
determine a set of sharable orders based on the matching information;
allocate the set of sharable orders, the allocation resulting in a maximum profit value associated with a combination of at least two sharable orders of the set of sharable orders; and
send out the combination of the at least two sharable orders to a service provider via the second signal transmission port in the service providing system.

2. The system of claim 1, wherein the plurality of orders includes at least one of a real-time order, an appointment order, or a pending order.

3. The system of claim 2, wherein the features of the plurality of orders include at least one of a start location, a destination, a mileage, a number of passengers, a pick-up time, an estimated fee, freight information, or vehicle information.

4. The system of claim 1, wherein to allocate the set of sharable orders, the logic circuits further:
determine a plurality of parameters associated with the features or the matching information;
determine a plurality of weighting coefficients for the plurality of parameters;
determine a plurality of relevance probabilities based on the plurality of parameters and the plurality of weighting coefficients, each of the plurality of relevance probabilities corresponding to two sharable orders in the set of sharable orders;
determine a plurality of relevance values based on the plurality of relevance probabilities, each of the relevance values corresponding to two sharable orders in the set of sharable orders; and
allocate the set of sharable orders based on the plurality of relevance values.

5. The system of claim 4, wherein the plurality of weighting coefficients is determined by training historical data.

6. The system of claim 4, wherein to allocate the set of sharable orders, the logic circuits further:
determine a maximum value of a sum of the plurality of relevance values;
divide the set of sharable orders into a plurality of order groups based on the maximum value, each group including two sharable orders; and
allocate the set of sharable orders based on the plurality of order groups.

7. The system of claim 1, wherein to allocate the set of sharable orders, the logic circuits further:
allocate the set of sharable orders based at least in part on a hill-climbing algorithm, a genetic algorithm, or a simulated annealing algorithm.

8. The system of claim 1, wherein to determine the matching information, the logic circuits further:
determine a first feature of a first order;
determine a plurality of pending orders within a predetermined distance from the first order, the plurality of pending orders corresponding to a plurality of providers;
determine a plurality of second features of the plurality of second pending orders, each of the plurality of second features corresponding to a second pending order;
match the first feature with the plurality of second features; and
determine the matching information.

9. The system of claim 8, wherein the first feature includes at least one of a first start location, a first destination, or first freight information; and wherein the first freight information includes at least one of a type of the freight, a length of the freight, a width of the freight, a height of the freight, or a weight of the freight.

10. (canceled)

11. The system of claim 9, wherein each of the plurality of second features includes at least one of a location of the provider, a second destination of the pending order, or second vehicle information; and wherein the second vehicle information includes at least one of a truck volume or a load capacity.

12. (canceled)

13. The system of claim 11, wherein to allocate the set of sharable orders, the logic circuits further:
determine a plurality of candidate pending orders based on the matching information, the plurality of candidate pending orders corresponding to a plurality of candidate providers;
determine a plurality of distances between a plurality of locations of the plurality of candidate providers and the first start location, each of the plurality of distances corresponding to one of the plurality of candidate providers;
rank the plurality of candidate providers based on the plurality of distances; and
allocate the first order to the plurality of candidate providers based on the ranking result.

14. A method, comprising:
obtaining, by at least one electronic device, a plurality of orders, each order associated with a request of a service and including a plurality of features;
determining, by the at least one electronic device, matching information of the plurality of orders based on the features of the plurality of orders;
determining, by the at least one electronic device, a set of sharable orders based on the matching information;
allocating, by the at least one electronic device, the set of sharable orders, the allocation resulting in a maximum profit value associated with a combination of at least two sharable orders of the set of sharable orders; and
sending, by the at least one electronic device, the combination of the at least two sharable orders to a service provider.

15. The method of claim 14, wherein the plurality of orders includes at least one of a real-time order, an appointment order, or a pending order.

16. The method of claim 15, wherein the features of the plurality of orders include at least one of a start location, a destination, a mileage, a number of passengers, a pick-up time, an estimated fee, freight information, or vehicle information.

17. The method of claim 14, wherein the allocating of the set of sharable orders includes:
determining, by the at least one electronic device, a plurality of parameters associated with the features or the matching information;
determining, by the at least one electronic device, a plurality of weighting coefficients for the plurality of parameters;
determining, by the at least one electronic device, a plurality of relevance probabilities based on the plurality of parameters and the plurality of weighting coefficients, each of the plurality of relevance probabilities corresponding to two sharable orders in the set of sharable orders;
determining, by the at least one electronic device, a plurality of relevance values based on the plurality of relevance probabilities, each of the relevance values corresponding to two sharable orders in the set of sharable orders; and
allocating, by the at least one electronic device, the set of sharable orders based on the plurality of relevance values.

18. The method of claim 17, wherein the plurality of weighting coefficients is determined by training historical data.

19. The method of claim 17, wherein the allocating of the set of sharable orders includes:
determining, by the at least one electronic device, a maximum value of a sum of the plurality of relevance values;
dividing, by the at least one electronic device, the set of sharable orders into a plurality of order groups based on the maximum value, each group including two sharable orders; and
allocating, by the at least one electronic device, the set of sharable orders based on the plurality of order groups.

20. (canceled)

21. The method of claim 14, wherein the determining of the matching information includes:
determining, by the at least one electronic device, a first feature of a first order;
determining, by the at least one electronic device, a plurality of pending orders within a predetermined distance from the first order, the plurality of pending orders corresponding to a plurality of providers;
determining, by the at least one electronic device, a plurality of second features of the plurality of second pending orders, each of the plurality of second features corresponding to a second pending order;
matching, by the at least one electronic device, the first feature with the plurality of second features; and
determining, by the at least one electronic device, the matching information.

22. The method of claim 21, wherein the first feature includes at least one of a first start location, a first destination, or first freight information; and wherein the first freight information includes at least one of a type of the freight, a length of the freight, a width of the freight, a height of the freight, or a weight of the freight.

23. (canceled)

24. The method of claim 22, wherein each of the plurality of second features includes at least one of a location of the provider, a second destination of the pending order, or second vehicle information; and wherein the second vehicle information includes at least one of a truck volume or a load capacity.

25. (canceled)

26. (canceled)
